(19) United States
(12) Patent Application Publication
(10) Pub. No.: US 2016/0231818 A1
(43) Pub. Date: Aug. 11, 2016

(54) Method for controlling an electronic device using a gesture command and a voice command

(71) Applicant: MULTIMEDIA IMAGE SOLUTION LIMITED, Dublin (IE)

(72) Inventors: ZhiWei Zhang, Hangzhou City (CN); ZhengHua Chen, Hangzhou City (CN); JianFeng Li, Hangzhou City (CN); Jin Wang, Hangzhou City (CN)

(21) Appl. No.: 14/619,076

(22) Filed: Feb. 11, 2015

(51) Int. Cl. G06F 3/01; G06F 3/16; A63F 9/24; A63F 13/21; A63F 13/215; G06F 3/00; H04N 5/44

(52) U.S. Cl. CPC G06F 3/017; G06F 3/005; G06F 3/167; H04N 5/4403; A63F 13/21; A63F 13/215; A63F 9/24; H04N 2005/4428; H04N 2005/4432; A63F 2009/2447; A63F 2009/2432

(57) ABSTRACT

To control an electronic device, a combination of a gesture command and a voice command are used. A motion sensor is used to detect the gesture command and a sound sensor is used to detect the voice command. When the combination of the gesture command and the voice command is detected, at least one function corresponding to the combination of the gesture command and the voice command is determined and the electronic device is controlled to perform the at least one function.

### BACKGROUND OF THE INVENTION

1. Field of the Invention

The present invention relates to a method for controlling an electronic device, and more particularly, a method for controlling an electronic device using a gesture command and a voice command to perform the at least one function.

2. Description of the Prior Art

Advancement in technology has allowed users to use gestures to control electronic devices. Though the use of gestures may be more convenient than using conventional remote controllers, the use of gestures alone to control electronic devices can still result in some problems. The problems include the sensitivity to light of the sensor for sensing the gesture, complicated gestures to make, redundancy of different gestures, and limited variety of usable gestures. If the sensitivity of the sensor is not high enough, background light prevents the sensor from determining a correct gesture. In some cases, gestures made are too similar to each other and are determined to have the same meaning when detected by the sensor. And, since only gestures are used to control the electronic device, a variety of gestures must be set to represent all the controls of the electronic device. Therefore, the gestures used to control the electronic device are more complicated to be able to differentiate the gestures from one another. Thus, there is a need to develop a technology able to increase the convenience and accuracy for controlling the electronic devices.

### SUMMARY OF THE INVENTION

An embodiment of the present invention presents a method for controlling an electronic device. The method comprises turning on the electronic device having a motion sensor and a sound sensor, detecting a gesture command using the motion sensor, detecting a voice command using the sound sensor, determining at least one function corresponding to a combination of the gesture command and the voice command, and controlling the electronic device to perform the at least one function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a method for controlling an electronic device according to an embodiment of the present invention.

FIGS. 2 to 4 illustrate examples of applications of the method in FIG. 1.

### DETAILED DESCRIPTION

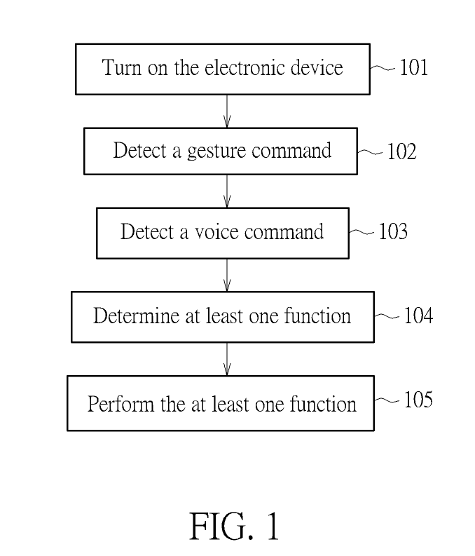

FIG. 1 illustrates a flowchart of a method for controlling an electronic device according to an embodiment of the present invention. The steps of the method for controlling the electronic device may include but is not limited to the following steps:

Step 101: turn on the electronic device having a motion sensor and a sound sensor;

Step 102: detect a gesture command using the motion sensor;

Step 103: detect a voice command using the sound sensor;

Step 104: determine at least one function corresponding to a combination of the gesture command and the voice command; and

Step 105: control the electronic device to perform the at least one function.

In step 101, the electronic device having a motion sensor and a sound sensor may be turned on. The electronic device may be a device having a motion sensor and a sound sensor such as a mobile phone having a microphone as the sound sensor and a camera as the motion sensor, a television having a microphone as the sound sensor and a camera as the motion sensor, or a camera having a microphone as the sound sensor and a camera as the motion sensor. Though, the present invention may not be limited to the above mentioned devices. The electronic device may also include a memory to store gesture commands and voice commands and a processor to identify and perform a function corresponding to the gesture commands and the voice commands.

Furthermore, it should be noted that the motion sensor is not limited to being a camera. The motion sensor may be any component able to sense any type of motion, of which may include a touch screen able to detect motion occurring on the touch screen or an accelerometer able to determine if the electronic device is in motion. The abovementioned motion sensors are only examples and are not meant to limit the present invention.

In step 102, the gesture command may be detected by the motion sensor; and in step 103, the voice command may be detected by the sound sensor. Steps 102 and 103 may be simultaneously performed or consecutively. If performed consecutively, step 102 is not limited to being performed before step 103. In some embodiments, step 103 may be performed before performing step 102. The order of detecting the gesture command and the voice command may be interchangeable from each other.

After the gesture command and/or a voice command have been detected, the combination of the gesture command and the voice command may be validated by comparing the combination of the gesture command and the voice command to combinations of gesture commands and voice commands stored in a memory. The combinations may not be limited to having only one gesture command and only one voice command. The number of gesture command and the number of voice command may vary depending on the need of the circumstance. Furthermore, the gesture commands and the voice commands in the memory may be user defined or pre-programmed.

In step 104, the at least one function corresponding to a combination of the gesture command and the voice command may be determined. After the gesture command and the voice command have been validated to be an existing gesture command and voice command in the memory, a corresponding at least one function of the gesture command and the voice command in the memory may be determined. A gesture command paired with different voice command may perform different at least one function. In the same way, a voice command paired with different gesture command may perform different at least one function.

In step 105, the electronic device may be controlled to perform the at least one function. After the at least one function has been determined by looking through the memory, the at least one function may be performed by the electronic device. The electronic device may use a user interface to control the electronic device and control the motion sensor and the sound sensor used to respectively detect the gesture commands, as well as control the electronic device to perform the corresponding at least one function.

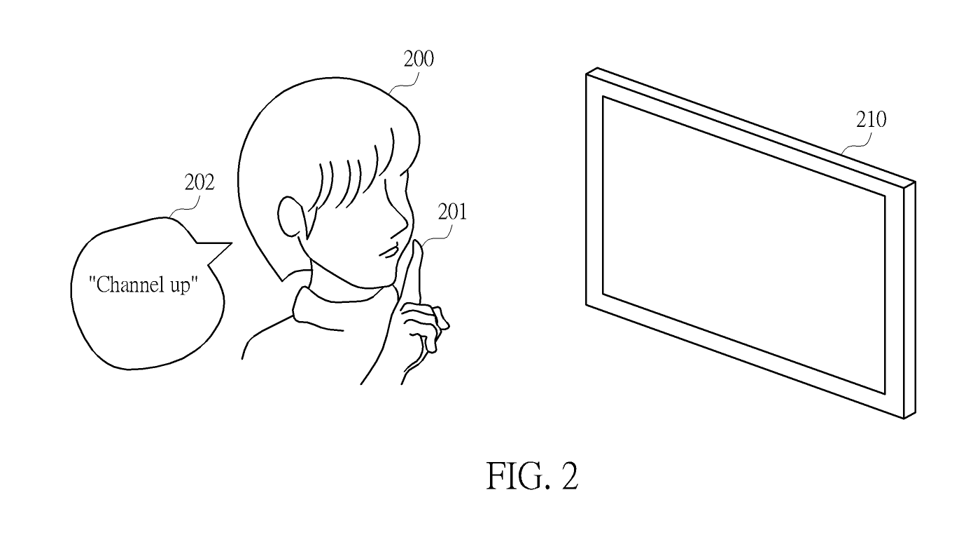

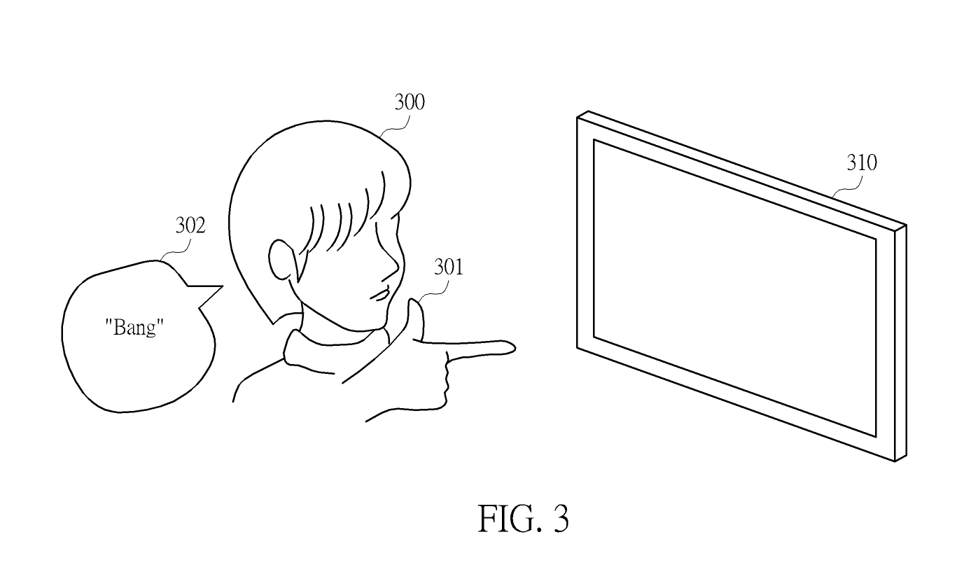

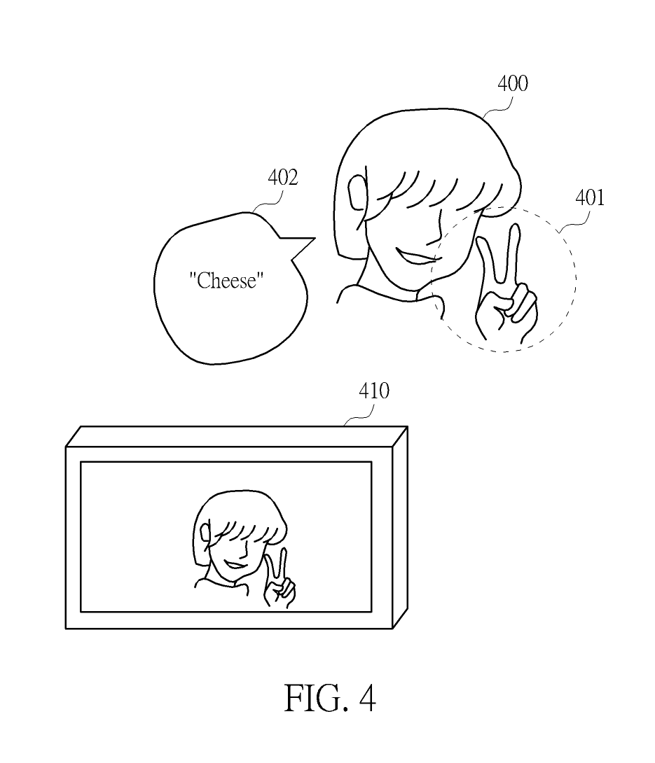

FIGS. 2 to 4 illustrate examples of applications of the method in FIG. 1. FIG. 2 illustrates an example of using the method in FIG. 1 to control a television. FIG. 3 illustrates an example of using the method in FIG. 1 to control a game console. And, FIG. 4 illustrates an example of using the method in FIG. 1 to control a camera.

According to the example in FIG. 2, a television set 210 may be controlled using a combination of gesture command 201 and voice command 202. Conventionally, to control the television set, a remote control is usually used. But a remote control may easily get lost or may get broken as time passes. Thus, eliminating the use of a remote control may be preferable to a user 200. When watching a television set 210, the volume may be turned up so that the whole room may hear. And it is also common practice to have a conversation while watching a program on the television set 210. To eliminate any false detection of a voice command. As shown in FIG. 2, a gesture command 201 may be combined with a voice command 202 to control the television set 210. The gesture command 201 may indicate a mute function. Thus, upon detection of the gesture command 201, the television set 210 may be muted. By muting the television set 210, the user 200 may eliminate any noise coming from the television set and allow the sound sensor to have a better detection of the voice command 202. The user 200 may then follow with a voice command 202, such as “volume up”, “volume down”, “channel up”, or “channel down”. The voice command 202 may be delivered while the gesture command 201 is still being performed and detected by the motion sensor. Note that the above mentioned gesture command and voice commands are only an example of implementing an embodiment of the present invention and is not meant to limit the scope of the invention.

According to the example in FIG. 3, a game console 310 may be controlled using a combination of gesture command 301 and voice command 302. Conventionally, a game console may be controlled using a controller or by using gestures. When the game console is controlled using gestures alone, some of the gestures may be a little difference in motion as compared to other gesture's motions. Thus, the motion sensor of the game console may not be able to differentiate the gestures and not be able to control the game console properly. As shown in FIG. 3, when a targeting game is being played using a game console 310, a gesture command 301 may be used to simulate a targeting weapon such as a gun. The gesture command 301 may be used to point to a specific location of the target. To shoot the targeting weapon, a voice command 302 may be used. The voice command may be “bang” or “piu”. The voice command 302 may be delivered while the gesture command 301 is still being performed and detected by the motion sensor. Note that the above mentioned gesture command and voice commands are only examples of implementing an embodiment of the present invention and is not meant to limit the scope of the invention.

In another embodiment of the present invention, the game console may be used to play an arcade game such as racing. When playing a racing game, the gesture command may be used to control the direction. The gesture command may be gestures similar to actions made when driving a car. The voice commands may be used to control sub functions of the game such as the speed or the brake.

According to the example in FIG. 4, a camera 410 may be controlled using a combination of gesture command 401 and voice command 402. Conventionally, taking a self-portrait using a camera is very difficult to do since the user needs to click on the control or a timer needs to be used to take a picture. Thus, several pictures need to be taken to be able to take a preferred picture. As shown in FIG. 4, when taking a self-portrait using the camera 410, the camera 410 may be positioned to capture a desired location. The user 400 may stand in the position and take the time to pose. When the user 400 is ready to take the picture, the user may give a gesture command 401 and a voice command 402. In FIG. 4, the gesture command 401 may be “V” shape formed by the fingers of the user and the voice command 402 may be words such as “cheese”. The use of the combination of the gesture command 401 and the voice command may allow the user 400 to capture a preferred picture. Note that the above mentioned gesture command and voice commands are only an example of implementing an embodiment of the present invention and is not meant to limit the scope of the invention.

Furthermore, in the abovementioned examples, the at least one function performed by the electronic device may not be executed if only the gesture command or the voice command is detected by the electronic device. Thus, increasing the accuracy of controlling the electronic device and prevent the electronic device for executing unwanted functions.

The embodiment of the present invention presents a method for controlling an electronic device by using a combination of a gesture command and a voice command. The electronic device may comprise a motion sensor to detect the gesture command, a sound sensor to detect the voice command, and a memory to store gesture commands, voice commands, and corresponding functions. The gesture commands, voice commands, and corresponding functions stored in the memory may be in a form of database or a lookup table and may be edited or reprogrammed according to a preference of the user. Thus, allowing a user to have a more convenient and more accurate control of the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling an electronic device, comprising:
turning on the electronic device having a motion sensor and a sound sensor;
detecting a gesture command using the motion sensor;
detecting a voice command using the sound sensor;
determining at least one function corresponding to a combination of the gesture command and the voice command; and
controlling the electronic device to perform the at least one function.

2. The method of claim 1, wherein the gesture command and the voice command are detected simultaneously.

3. The method of claim 1, wherein the gesture command and the voice command are detected consecutively.

4. The method of claim 1, further comprising:
validating the combination of the gesture command and the voice command by comparing the combination of the gesture command and the voice command to combinations of gesture commands and voice commands stored in a memory.

5. The method of claim 4, wherein the gesture commands and the voice commands in the memory are pre-programmed.

6. The method of claim 4, wherein the gesture commands and the voice commands in the memory are user defined.

7. The method of claim 4, wherein the memory stores a plurality of combinations of a gesture command and a voice command to perform the at least one function.

8. The method of claim 1, wherein the gesture command and the voice command correspond to a single function.

9. The method of claim 1, wherein the gesture command and the voice command correspond to different functions.
